(19) United States
(12) Patent Application Publication
(10) Pub. No.: US 2007/0192178 A1
(43) Pub. Date: Aug. 16, 2007

(54) Transaction method and system

(75) Inventors: Ho Chung Nicholas Fung, Singapore (SG); Chu Yong Sang, Singapore (SG)

Correspondence Address: NIXON PEABODY, LLP, 401 9TH STREET, NW, SUITE 900, WASHINGTON, DC, 20004-2128, US

(73) Assignee: ONEEMPOWER PTE LTD, Singapore (SG)

(21) Appl. No.: 10/566,174

(22) PCT Filed: Jul. 14, 2004
(86) PCT No.: PCT/IB04/51222

§ 371 Date: Sep. 12, 2006

(30) Foreign Application Priority Data
Aug. 6, 2003 (SG) 200304811-3

(51) Int. Cl. G06Q 30/00

(52) U.S. Cl. 705/14

(57) ABSTRACT

A transaction system (10) for use by users, comprising: electronic tokens (24) for storing and processing token transaction data (28) and token reward data (30), each for use by a respective user; a computer server (12) for storing and processing server transaction data (32) and server reward data (18) associated with each of the tokens (24); and user interaction devices (14,16) for communicating with the server (12), at least one of which (14) having a token acceptor device (15) for reading from and writing to the tokens (24); wherein the transaction data (28,32) are indicative of at least one transaction and the reward data (30,18) are indicative of earned rewards, the system (10) being operable to transfer server reward data (18) to a respective token (24) and token reward data (30) to the server (12) by means of the user interaction device (14) provided with a token acceptor device (15), so that rewards are redeemable according to reward data (30) on the token (24) or reward data (18) stored on the server (12).

### FIELD OF THE INVENTION

The present invention relates to a method and system for performing transactions, of particular but by no means exclusive application in calculating and awarding rewards to customers enrolled in a rewards program, which can be used in both online and offline environments, and to an electronic token for use in such a system.

### BACKGROUND OF THE INVENTION

The following description refers to, inter alia, the use of Customer Interaction Devices (CIDs) that may be equipped with Token Acceptor Devices (TADs) for reading data from and writing data to ‘smart’ electronic tokens such as smart cards (collectively referred to as tokens).

Existing customer rewards systems that use tokens for rewards management involve processing and computation of rewards in CID/TADs. Such systems are only able to make use of the limited amount of customer profile information available in a customer's token.

Prior art reward systems also focus on customer rewards centred on the token, or the host server, and do not provide a consolidated approach to customer rewards which takes into account customer activities through all channels, including those that do not involve the use of a token.

Further, in prior art token-based systems, transaction information from CID/TADs is eventually consolidated and tracked in a central host server. Such systems typically suffer from reconciliation difficulties, where the reward balances tracked in the token do not reconcile with the balances in the host server accumulated from the data sent from the CID/TADs. The main reasons for such discrepancies include the loss of transaction data from the CID/TAD prior to the data being received in the host server and, in a second instance, problems arising during the updating of the token (known in the industry as ‘torn’ or ‘broken’ transactions).

It is an object of the present invention to at least reduce this problem by providing a reward system and method that can combine the rewards awarded at CID/TADs in an offline mode with computation and award of rewards performed at a server (such as a host computer system) in an online mode, where rewards computation can be based on greater quantities of customer information.

### SUMMARY OF THE INVENTION

The present invention provides therefore a transaction system for use by a plurality of users, comprising:

a plurality of electronic tokens for storing and processing token transaction data and token reward data, each of said electronic tokens for use by a respective user;

a computer server for storing and processing server transaction data and server reward data associated with each of said respective tokens; and

a plurality of user interaction devices for communicating with said server, at least one of which is provided with a token acceptor device for reading from and writing to said tokens;

wherein said server transaction data and said token transaction data are indicative of at least one transaction and said server and token reward data are indicative of rewards or entitlements earned or otherwise awarded, and said system is operable to transfer, for a respective token, server reward data from said server to said respective token and token reward data from said respective token to said server by means of said user interaction device provided with a token acceptor device, whereby said rewards or entitlements are redeemable either according to reward data stored on said token or according to reward data stored on said server.

Thus, reward data is available offline (i.e. on each token) and online (i.e. on the server), and can be transferred between these two as at least one of the user interaction devices has a token acceptor device for reading from and writing to the token. This enables a business to provide comprehensive customer rewards that takes full cognisance of the customer's relationship with that business. As an example, a typical reward system may award more points to a Customer A who makes a larger purchase at a CID/TAD compared with a Customer B who makes a smaller amount of purchase. However, Customer B actually may have a broader and deeper relationship with the reward program operator (e.g. a bank).

For example, Customer A may be just a credit card customer of the bank for only a month, whereas Customer B has been with the bank for 10 years and has a multi-product relationship with the bank, such as having fixed deposits, housing loans and unit trust investments, in addition to being a credit card customer.

Instead of awarding more points to Customer A, Customer B should receive more (despite the smaller purchase amount). Therefore, it would be unjust merely to award a customer simply according to an instant prevailing transaction taking place at a CID/TAD: this can be avoided by means of the present invention.

Preferably each of said tokens is additionally adapted to store token user data pertaining to said respective user. Further, preferably the server is additionally adapted to store server user data pertaining to said respective user.

In one embodiment, each of the tokens is additionally adapted to store token user data pertaining to said respective user, the server is additionally adapted to store server user data pertaining to said respective user, and said system is operable to synchronize said token user data with said server user data for a respective user when the respective token of said user is used with one of said user interaction devices having a token acceptor device.

Preferably the system is operable by each of said users 1) to transfer reward data from said server to a respective token of said respective user so that said respective user can redeem said rewards or reward points by presentation of said token, and 2) to transfer reward data from a respective token of said respective user to said server so that said respective user can redeem said rewards or reward points by communicating with said server. More preferably each of the user interaction devices is operable to send said token transaction data and said reward data to said server.

Preferably each of the tokens is any one of: an integrated circuit chip card (commonly known as smart card), a chip in a mobile telephone, a chip in a personal digital assistant, a chip in a watch, and a chip in a key chain, wherein each of said tokens is operable to interact with said token acceptor device.

Further, the interaction between the tokens and the token acceptor device may be either in contact or contactless modes. The former may comprise inserting the token into a slot or swiping the token through a slot; the latter may comprise using the mobile telephone network, radio frequency, infra-red or Bluetooth (™) wireless communications technology.

Preferably the transaction data includes, for each transaction, unique transaction identification data.

Thus, the transaction data preferably includes data pertaining to specific transactions, but additionally this data should preferably include unique identification data identifying that transaction.

Preferably the system is operable to transfer data between said server and said tokens so that said system can reconcile said transaction data or said reward data.

Preferably the user interaction devices are provided with processing software for computing entitlements from said transaction data and recording said transaction data and entitlement or rewards data in said user interaction device, and for recording said transaction data in said tokens when said tokens are presented at said user interaction devices in the course of a transaction or activity.

Preferably said server is operable to check said transaction data for duplicates and to record transactions that are not duplicated, and to accumulate the reward data for respective said transaction data in said rewards data in said server.

Preferably the transaction or activity comprises any one of: a purchase transaction, a payment transaction, a cash withdrawal transaction, a transaction to consume or redeem an entitlement, a visit, a subscription to a service, a use of a service, a retrieval of information, a request for information, a submission or provision of information, an application for membership, an access to a web page, a participation in an event, and a registration for a particular activity.

Preferably each of said tokens is further adapted to store redemption data indicative of previously redeemed rewards or reward points.

Preferably the user interaction devices are provided with processing software for computing an available balance of entitlements from at least some of said token transaction data, said redemption data, and said token reward data.

Preferably the user interaction devices are operable to display or print an available balance of entitlements.

Preferably the user interaction devices are operable to prompt a respective one of said users for an input indicative of whether said respective user wishes to redeem any reward according to an available balance of entitlements in an instant transaction.

Preferably the system is operable to transmit said transaction data and said respective reward data for each of said transaction records in said user interaction device to said server, and said server is operable to check said transaction data for duplicates, to discard duplicates, to record said transaction data that are not duplicated and to accumulate said respective reward data in said server reward data.

Preferably at least some of said user interaction devices are configured to transmit to said server said token transaction data corresponding both to an instant transaction and one or more previous transactions, thereby providing redundancy in the transaction data received by said server.

Thus, it is possible by this approach to ensure a high degree of reliability and synchronicity of the data on token and in the server, by means of this redundant transfer of transaction data in which data is sent from two independent CID/TADs to ensure integrity and completeness of data received at the server.

Preferably the system is configured to reconcile said token transaction data and said token reward data with said server transaction data and said server reward data when any of said respective tokens is used with a user interaction device provided with a token acceptor device for reading from and writing to said tokens.

Preferably the system is configured to upload said token transaction data of a respective token to said server and thereby synchronize said respective token with said server, when said token is used with a user interaction device capable of data communications with said server and provided with a token acceptor device for reading from and writing to said token, and the token transaction data in said respective token having been previously added to said token when previously used with a user interaction device and where said token transaction data has not been previously transmitted to said server.

Thus, this embodiment addresses the aforementioned problem of many token-based systems: the accuracy of data in the token. The embodiment allows the redundant collection of data at the server to ensure a high degree of reliability and synchronicity of the data on token and in the server. A unique mechanism is disclosed by which data is sent from two independent CID/TADs to ensure integrity and completeness of data received at the server.

Preferably the server is configured to receive transaction and activity data corresponding to transactions or activities of a respective user on other business systems that do not incorporate the use of the respective token of said user, for determining rewards or entitlements to be awarded for said transactions and said activities, and recording the balance of such entitlements in said reward data corresponding to said respective user.

Preferably the system is configured to associate a respective username and password combination with each respective token, so that the respective user associated with said respective token can access said server reward data pertaining to said token by communication with said server and without said respective token.

Preferably, when said token reward data of a respective token is transferred to said server (preferably at the specific request of respective user of said token), said transferred token reward data is incorporated into said respective server reward data pertaining to said respective token, and removed from said respective token.

Preferably, when said server reward data corresponding to a respective token is transferred to said respective token (preferably at the specific request of respective user of said token), said transferred server reward data is incorporated into said respective token reward data of said respective token, and removed from said server.

In one embodiment, the system is for use by a plurality of Providers of goods, services or both goods and services.

In another embodiment, the system is for use by a plurality of groups of Providers, each group comprising one or more Providers, each of said groups providing a set of entitlements to said users, and each of said groups having its own set of business rules for awards and redemptions of entitlements, wherein balance information of said set of entitlements is kept in each of said tokens and, for each of said set of entitlements, said server holds one set of offline reward data (preferably token reward data) and one set of server reward data.

Preferably rewards can be transferred from a first of said tokens to a second of said tokens by transferring either token reward data or server reward data from said first to said second token, subject to business rules set by the respective Providers.

Preferably the transfer is effected by means of one or more of said user interaction devices configured to transmit information about said transfer to said server for updating the server reward data corresponding to said first token and said second token.

Preferably the user interaction devices are located in a plurality of countries, said countries collectively employ a plurality of currencies, and said user interaction devices in each of said countries transact in a respective local currency, and wherein said tokens contain entitlement information based on said token reward data converted to the local currency of the respective user interaction device by said user interaction device or by said server so that an entitlement can be redeemed in a respective country.

Preferably the system is configured to convert entitlement information awarded by a respective said user interaction device in a local currency to the currency of said respective token.

Preferably each group of a plurality of groups of Providers maintains in each of said tokens profile data relating to said respective group and of a user of said respective token, wherein a first of said groups of Providers can establish a business relationship with a second of said groups for the purpose of sharing the whole or parts of said profile data relating to said second Group, and ask a particular user at one of said user interaction devices of said first Group, during a transaction or activity, for permission to use said profile data for making an offer relevant to said respective user according to business rules encoded in said user interaction device, wherein user interaction device is provided with a token acceptor device for reading from and writing to said tokens and said user of said respective token can indicate consent by entering a password or PIN, which is used by said user interaction device to access said profile data.

Preferably the system is operable to allow a first of said users to leave a standing instruction recorded in said server to transfer entitlements from said server reward data to credit a specified account.

Preferably the specified account is adapted to receive said transferred entitlements as payments of insurance premiums, for telecom bills, utility bills, outstanding loans or for other goods or services, the reward data of another set of entitlements of the same user or the reward data of another set of entitlements of another user, and said transfer can be effected on a regular basis or when a set of specified conditions are met.

The invention also provides a method for performing transactions by a plurality of users, comprising:

providing a plurality of electronic tokens for storing and processing token transaction data and token reward data, each of said electronic tokens for use by a respective user;

providing a computer server for storing and processing server transaction data and server reward data associated with each of said respective tokens; and

providing a plurality of user interaction devices for communicating with said server, at least one of which is provided with a token acceptor device for reading from and writing to said tokens;

wherein said server transaction data and said token transaction data are indicative of at least one transaction and said server and token reward data are indicative of rewards or entitlements earned or otherwise awarded, and said system is operable to transfer, for a respective token, server reward data from said server to said respective token and token reward data from said respective token to said server by means of said user interaction device provided with a token acceptor device, whereby said rewards or entitlements are redeemable either according to reward data stored on said token or according to reward data stored on said server.

The present invention also provides a transaction system for use by a plurality of users, comprising:

a plurality of electronic tokens for storing and processing token activity data and token reward data, each of said electronic tokens for use by a respective user;

a computer server for storing and processing server activity data and server reward data associated with each of said respective tokens; and

a plurality of user interaction devices for communicating with said server, at least one of which is provided with a token acceptor device for reading from and writing to said tokens;

wherein said server activity data and said token activity data are indicative of at least one activity and said server and token reward data are indicative of rewards or entitlements earned or otherwise awarded, and said system is operable to transfer, for a respective token, server reward data from said server to said respective token and token reward data from said respective token to said server by means of said user interaction device provided with a token acceptor device, whereby said rewards or entitlements are redeemable either according to reward data stored on said token or according to reward data stored on said server.

Thus, it should be understood that, while the principal application of this invention may be in the area of rewards systems in which benefits are paid for transaction activity, it may also be used where other types of rewards are earned in response to other types of activities. For example, an activity might comprise engaging in work in which case the reward or entitlement will comprise wages, in which case the transaction is the exchange of labour and wages. For example, in environments such as offshore oil fields and mining areas where communication with a host computer is difficult or expensive, the tokens can be used to store activity data (e.g. hours worked) and reward or compensation data (e.g. wages derived from transaction data on the tokens and formulas on the user interaction devices). Wages can then be paid to the users (e.g. in the form of cash) by reading the reward data from the tokens. It is possible that additional benefits (such as medical or educational benefits) may also be included in the reward data and ultimately paid to the users (such as owing to changes in regulatory or union rules) and such data may be updated in the server but not initially in the tokens. Data on the token and the server are then preferably synchronized whenever communication between the user interaction device (with a token acceptor) and the server is possible.

Alternatively, the activity might comprise a weight-loss program, in which the activity of losing weight is rewarded by cash, credits, points or other negotiable entitlement.

### BRIEF DESCRIPTION OF THE DRAWING

In order that the invention may be more clearly ascertained, preferred embodiments will now be described, by way of example, with reference to the accompanying drawings, in which:

FIG. 1 is a schematic diagram of a transaction system for conducting a customer rewards program according to a preferred embodiment of the present invention.

### DETAILED DESCRIPTION OF THE PREFERRED EMBODIMENT

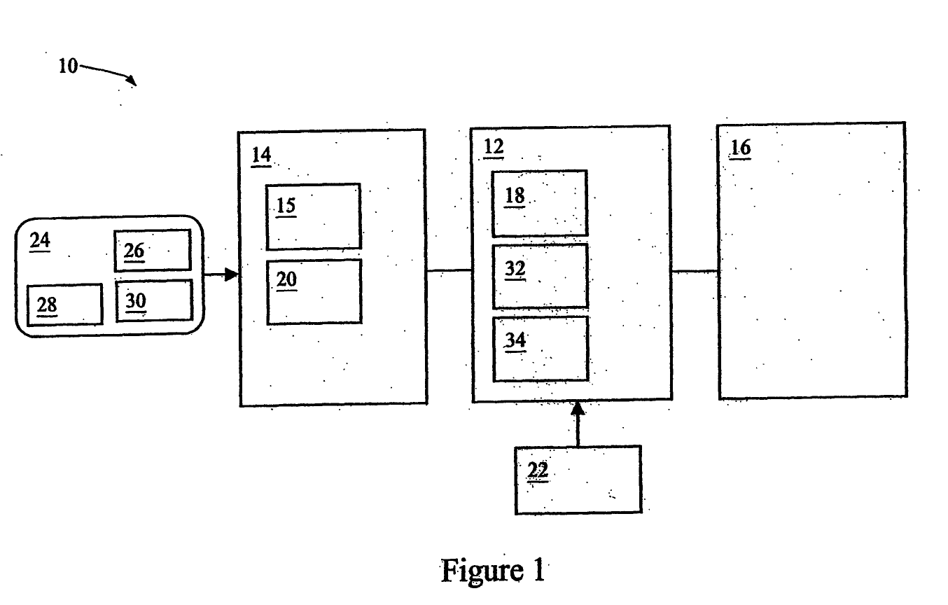

A transaction system for conducting a customer rewards program according to a preferred embodiment of the present invention is illustrated schematically at 10 in FIG. 1. The system 10 includes a computer server in the form of Host Computer System 12 (which may in fact comprise a plurality of computers) for computing and storing details of user or customer activity and rewards. The system 10 includes a plurality of user or customer interaction devices (CIDs) located at various vendors or Providers (viz. of goods or services) that are participating in one or more of the rewards schemes; some of the CIDs include a Token Acceptor Device (TAD) 15 and each is therefore referred to as a CID/TAD 14. Some of the CIDs do not have a TAD, and each of these is therefore referred to as a CID/noTAD 16. Further, some of the CIDs are in comunication with the Host Computer System 12, but some are not.

The reward details are stored in database Host Rewards 18 on the Host Computer System 12, and are derived from transaction data received from the CIDs 14, 16 at the points of interaction with the customers of the Providers. Each transaction between a customer and a Provider is assigned a transaction identifier, which is added to a Processed Transaction IDs database 18 also on the Host Computer System 12.

The CID/TADs 14 can be in a number of forms, such as a point of sale device (POS) provided with a TAD 15, an automatic teller machine (ATM) provided with a TAD 15, a remote communciations device (such as a mobile phone or personal digital assistant) equipped with or in communication with a TAD 15, or an Internet access point equipped with a TAD 15. Each CID/TAD 14 also maintains its own transaction log referred to as Txn Log 20.

Each of the CID/noTADs 16 may be in the form of a POS, an ATM, a remote communciations device such as a mobile phone or personal digital assistant, an Internet access point, a telephone for calling into an Interactive Voice Response system, a telephone for calling to a call centre or an arrangement for mailing a centre set up to process mailed instructions. None, however, is equipped with a TAD.

In addition, the system 10 includes other sources 22 of activity and transaction data, such as external business application systems.

Thus, from all of the CIDs 14, 16 and such business application systems 22, the Host Computer System 12 can receive customer activity and transaction data for electronic processing, some or all of which may be received in real-time and some or all of which may be received on a delayed, batched basis.

The system 10 also includes customer Tokens 24, each held by a respective customer and—in this embodiment—in the form of a smart card useable for storing data. The data stored on the Tokens 24 can be updated at the CIDs 14 with TADs 15 at the various points of interaction (e.g. POSs, mobile phones, internet acess points); the Tokens 24 has encoded in it information related to the customer, specifically, Customer Info 26, Transaction Details 28 and Token Rewards Records 30.

Transactions processed by the Host Computer System 12 are logged in a Host Txn Log 32, with each transaction identified by a unique transaction ID.

Customer Info 26 on each Token 24 contains various pieces of information about the customer that a Provider of rewards may wish to use for determining the entitlement rules for the respective customer, and can include, for example, a customer's sex, age or age group, income bracket, occupation, and types of products used by the customer.

The Transaction Details 28 are records of customer transactions carried out with a respective Token 24 that entitle the customer to rewards, and include sufficient information for a CID/TAD 14 to compute the customer's entitlement for each of the Transaction Details 28 records.

The Token Reward Records 30 contains the sum total of accumulated rewards in Host Rewards 18 and Token Rewards 34 (defined further below). The Token Rewards Records 30 can hold records of multiple types of rewards, e.g. in the form of different types of points, e-coupons and e-tickets, each reward type corresponding to a reward type in Host Rewards 18 and Token Rewards 34.

Host Rewards 18 contains records of rewards that have been derived from the customer's activities at various points of interactions, using different products and services of the rewards Providers,such as activity and transaction data from all the CIDs 14, 16 and business application systems 22, the customer being uniquely identified in the system 10 by a User Id or User Name, by means of which—together with an associated password or PIN—the user may gain access to the Host Rewards 18 records for, interalia, conducting a balance enquiry, redeeming rewards or transferring of rewards from one reward type to another, or from one user to another.

Token Rewards 34 are the balance of rewards and entitlements awarded to the customer by CID/TADs 14 in offline modes and uploaded to the Host Computer System 12 and updated into Token Rewards 34. The value in Token Rewards 34 tracks awards made offline in CID/TADs 14 and is used by the Host Computer System 12 to track the total amount of outstanding rewards in Token 24. This value is frequently not the latest figure, as offline transactions taking place between Token 24 and a CID/TAD 14 are not posted to this balance immediately but on a delayed ‘batched’ basis. This value is, however, generally adequate for determining to a close approximation the amount of rewards outstanding in Token 24.

The User Id or User Name of a particular customer is preferably associated with the Token 24 assigned to that customer, and with all the products and service accounts that the customer may have with a respective business.

In transactions where a Token 24 is used in an activity or business transaction for which rewards may be awarded, the CID/TAD 14 records the business transaction details as Transaction Details 28 onto the Token 24 when the customer uses the Token 24 at the CID/TAD 14. Such a system allows offline awards to be made and is particularly suited for environments where data communications is costly or not universally available.

When operating in offline mode, the CID/TAD 14 computes the total rewards entitlement of the customer at any one time by summing up the rewards as recorded in the Token Rewards Records 30, the Transaction Details 28 (including the current transaction) and any Customer Info 26 required for the determination of entitlements as defined in business rules stored in the CID/TAD 14 and Token 24. The CID 14 prints and/or displays a new Total Entitlement (i.e. available rewards after the instant transaction) at the time of each transaction. The new entitlement is not recorded in the Token 24, in order to reduce the number of updates made to the Token 24 to a single record for each transaction, that is, only the instant Transaction Detail record is added to the Transaction Details 28 on Token 24. The new Total Entitlement does not include any rewards that may have been awarded to the customer in batch mode and recorded in Host Rewards 18 and which have not been included in the Token Rewards Record 30 which was last downloaded from the Host Computer System 12.

The CID/TADs 14 send the Transaction Details 28 data to the Host Computer System 12, either in real-time or on a delayed basis in batches (‘batch mode’), together with the entitlements that were computed in the CID/TAD 14 in offline mode and displayed and/or printed at the CID/TAD 14 at the time of transaction.

Every activity or transaction is uniquely identified, whether with a Transaction Id, a sequential number unique to a specific Token 24 and transactions conducted with that Token. Each Transaction Id is included in the Transaction Details 28 and is sent to the Host Computer System 12. The Transaction Id may alternatively comprise some combination of data from the Transaction Details 28 record, such as Provider Id, CID Id, Transaction Date and Time, etc. In the Host Computer System 12, the Transaction Details 28 are checked against Host Txn Log 32 for duplicates, any duplicate being discarded, and then processed together with entitlement data, according to business rules that the Provider deems advantageous to its business. Further entitlements to be awarded to the customer, if any, are thus determined, and the additional entitlements are updated in Host Rewards 18. The Transaction Details 28 are logged in the Host Txn Log 32. Entitlements awarded by the CID/TAD 14 are recorded separately in the Token Rewards 34.

Thus, the system 10 provides for redundant transmission of transaction data from the CID/TAD 14 to Host Computer System 12: from a CID/TAD 14 at which a particular transaction actually takes place, and secondly from a subsequent CID/TAD 14 that retrieves the Transaction Details 28 pertaining to that particular transaction and sends them to the Host Computer System 12. Either one may take place first, as the first CID/TAD 14 may be operating in batch mode. In both cases, the computed rewards for the Token 24 will be correct and complete. The redundant transmission of transaction data increases the reliability of the system and ensures that the Token data can always be reconstructed reliably.

Entitlements are also computed based on inputs from external business application systems 22, if any are involved, and the computed entitlements included in the Host Rewards 18. The customer may then access the Host Rewards 18 from the various CIDs 14, 16 for the purpose of making enquiries or claiming the rewards.

Access without Tokens

When accessing the records in the Host Computer System 12 from CID/noTADs 16, the customer manually enters his User Id or some proxy thereof by means of a keyboard or keypad (or some other data entry device) at the point of interaction, followed by a password or pass code to verify the customer's authenticity.

Upon gaining access, the customer can choose to claim or redeem the rewards recorded in Host Rewards 18, which may be in the form of gifts or gift vouchers, which are sent to the customer via traditional delivery channels, or in the form of ‘points’ which can be converted into price discounts for products and services or for fee waiver or discount entitlements, from the same or some other Provider or plurality of other Providers, and such entitlements can then be electronically transmitted to the business application system 22 which recognises the entitlement accordingly.

Access with Tokens

At Providers or other customer touchpoints with a CID/TAD 14, the customer accesses the Host Rewards 18 in the Host Computer System 12 by first presenting the Token 24. Upon authentication of the Token 24 and user, typically through use of cryptographic algorithms and Personal Identification Numbers (PINs) according to conventional techniques, the system 10 associates Token 24 with the customer's records in the Host Computer System 12, and then allows the customer to claim any rewards directly (i.e. online, in which case the records in the Host Computer System 12 are updated and the customer is given those rewards or benefits), or entitlements recorded in Host Rewards 18 are transferred to the Token Rewards Records 30 in the Token 24 for later redemption. The customer may then redeem the value stored in the Token Rewards Records 30 by presenting the Token 24 at points of interaction equipped with CID/TADs 14; such claims are processed by the CID/TAD 14 in use at the point of interaction and the claim record is updated in the Token 24 as well as recorded in the CID/TAD 14. The latter records are subsequently sent to the Host Computer System 12 for updating into Token Rewards 34 for tracking and reporting.

The Host Computer System 12 can use the Token Rewards 34 to determine, to some degree of accuracy, the amount of rewards outstanding in Tokens 24, for the purpose of management reports and decision support.

In cases where the rewards in Host Rewards 18 are ‘transferred’ or ‘downloaded’ from the Host Computer System 12 into the Token 24, the transfer or download can be initiated by the customer (with the permission of the Provider), or initiated automatically by the CID/TAD 14 when specific conditions required by the Provider or plurality of Providers involved are met. For example, where the Token 24 is used in connection with a service (e.g. a payment service) that requires frequent online connection to the Host Computer System 12 from the points of interaction (CID/TAD 14), the download can occur frequently, such as on every Nth contact; N is a number determined by the Provider, and would be a function of the frequency of Host Computer System 12 awards. In an environment where the Host Computer System 12 frequently processes many transactions from other application sources 22, N may be set lower, in order to update the Token Rewards Records 30 more frequently.

A customer may, from a CID/TAD 14, access Host Rewards 18, which have been computed in the Host Computer System 12 based on activity and transaction data from all the CIDs 14, 16 and business application system 22; the customer may then initiate the transfer of rewards from Host Rewards 18 into the Token 24 for updating the Token Rewards Records 30.

The system 10 may also be configured so that, each time a CID/TAD 14 has online access to the Host Computer System 12, it sends all Transaction Details 28 from the Tokens 24 to the Host Computer System 12, together with the entitlement details for each of the transactions in Transaction Details 28. In the Host Computer System 12 the Transaction Details 28 are checked against the Host Txn Log 32 to determine if they have already been processed before, that is, whether the CID/TAD 14 where the transactions recorded in the Transaction Details 28 occurred have previously sent the transaction data to the Host Computer System 12 for processing. Any duplicates are discarded or logged in a separate log file for information purposes in the Host Computer System 12.

Those transactions without duplicates are logged in the Host Txn Log 32 and processed: rewards entitlements received from the CID/TAD 14 are accumulated in the Token Rewards 34, and any further entitlements for each of the Transaction Details 28 are computed and accumulated in the Host Rewards 18. On completion of the computation based on all the Transaction Details 28 stored—for that customer—on the Host Computer System 12, the sum of rewards in Host Rewards 18 and Token Rewards 34 are sent to the CID/TAD 14 for updating into the Token Rewards Records 30 in the Token 24. The Transaction Details 28 records in the Token 24 are marked as cleared (i.e. Processed), to allow future transactions to be recorded in their place. The Host Rewards 18 values are also added to Token Rewards 34, and Host Rewards 18 are reset to zero to signify that the values have been transferred to the Token Rewards Records 30.

Offline Redemption

A customer may initiate an ‘offline redemption’ request, where the transaction is completely processed and approved at a CID/TAD 14 without the involvement of Host Computer System 12, using the data in the Token 24, including entitlements for each Transaction Details 28 record which has not been marked as Processed (such entitlements being determined by the CID/TAD 14 computing the entitlements using data in Transaction Details 28 and also where required data in Customer Info 26, depending on the business rule); these results are summed with the rewards from Token Rewards Records 30 to determine the Total Entitlements, i.e. the total entitlement available for redemption. The Total Entitlements exclude previous redemption amounts recorded in the Transaction Details 28, and exclude Transaction Details 28 records which have been marked as Processed.

When an offline redemption transaction has been performed successfully, the redemption details are also inserted as a record into the Transaction Details 28. This redemption amount will be deducted from the Total Entitlements the next time the total rewards is computed. Such offline redemptions are effected between the CID/TAD 14 and the Token 24 without involvement of the Host Computer System 12 at the time of redemption, thus saving on the telecommunications cost and time.

During such offline redemptions, only the transaction details are updated into the Token 24 in Transaction Details 28; the balance of available rewards in the Token Rewards Records 30 are not updated. This single update reduces the possibility of ‘broken transactions’ and increases the reliability of the system, as well as ensures that the total entitlement of the customer can be reconciled with the Host Computer System 12 simply by sending the records in Transaction Details 28 to the Host Computer System 12.

Upload of Rewards from Token to Host

The system 10 further allows the customer to upload Token Rewards Records 30 and entitlements computed from Transaction Details 28 which have not been marked as Processed from the Token 24 to the Host Computer System 12 from CID/TAD 14; the Host Computer System 12 then computes and updates the new Host Rewards 18 based on the Transaction Details 28 and Token Rewards Records 30. The records in Transaction Details 28 are marked as Processed and the Token Rewards Records 30 are set to zero (0).

After it is recorded in the Host Computer System 12 in Host Rewards 18, the customer may access the Host Rewards 18 to redeem them for gifts and other benefits from a variety of CIDs 14, 16, including those CIDs 16 without TADs. The Host Computer System 12 may be accessed for this purpose either via a CID such as a telephone connecting to an IVRS, a mobile or Internet CID, where a TAD is not available, and where the customer is identified by means of a User Id and password or some other form of personal identification number or code entered by the user or spoken by the user into the CID at the time of access.

In this configuration, when accessing the Host Computer System 12 using a Token 24 at a CID/TAD 14, the user name/password is not required. A PIN may be required depending on the Provider. The redemption request is sent to the Host Computer System 12 in real-time and is processed in the Host Computer System 12, and the rewards status is updated and recorded in the Host Computer System 12.

After such an upload, the rewards recorded in the Token 24 in Token Rewards Records 30 is set to zero; none are then be available for offline redemption.

Plurality of Reward Types

The Token Rewards Records 30 and Host Rewards 18 may comprise multiple reward types. Token Rewards 34 comprises the same reward types as Token Rewards Records 30. Each of the reward types carries a different monetary value or a different type of benefit, and each is subject to its respective terms and conditions. There may also be a plurality of Provider groups, each group comprising different providers, and each group having its own set of reward types.

A Provider may participate in more than one group.

Each customer can therefore benefit from the different groups of providers and types of rewards when they patronise the Providers who are members of different groups.

Customer Entitlement

The customer may be awarded different rewards based on the customer's profile, including nature of transaction and activity, types of goods or services patronised, activity and transaction history and demographic data. Thus, two customers performing the same transaction may each receive different benefits because of their different profiles. Further, a customer may be required to expressly opt to participate in a given reward type by enrolling in that reward type, and providing the enrollment information required by the Providers in the reward type.

Rewards Conversion

A customer may be permitted, under conditions which a Provider or a plurality of Providers determine to be advantageous, to convert one reward type into another, at an exchange rate determined by the Provider or Providers offering the reward. Such a conversion may be effected by the customer, through a CID/TAD 14, by selecting the Token Rewards Records 30 or Host Rewards 18 to be converted, and the Token Rewards Records 30 or Host Rewards 18 to which it is to be converted to. The CID could then be made to display or otherwise communicate (e.g. aurally) the conversion rate to the customer, and allow the customer to choose to proceed with the conversion or cancel the operation.

Contribution to Rewards

Each reward type may be contributed to by a different Provider or by a group of Providers, each member Provider of a group contributing a proportion according to mutually agreed rules, and the plurality of Providers may be hosted on the same Host Computer System 12.

A transaction carried out at a first Provider may entitle the customer to a First Reward Type provided that customer meets criteria set by that first Provider. The First Reward Type may be contributed to by both the first Provider, and optionally by further Providers (collectively the Contributing Providers) with whom the first Provider has a prior agreement.

A transaction carried out at the first Provider may entitle the customer to a plurality of reward types, provided the customer meets criteria set by the Providers contributing to the respective reward type; each type of reward may be contributed to by one or by a plurality of Contributing Providers with whom the first Provider has prior agreements.

The system 10 allows the first Provider to offer incentives to its customers with funding from the Contributing Providers, the Contributing Providers benefiting from having made contact with customers of the first Provider. For example, the Token 24 may be used for, say, a payment service with a rewards application. In this case, a first Provider (the payment service Provider) may offer a reward coupon (such as a 20% discount coupon) redeemable at a second Provider if the customer uses the Token 24 with the payment service more than N times in a given time period at the First Provider.

The second Provider accepts the coupon for redemption because the first Provider has helped the second Provider to establish contact with additional customers. The process of computing and awarding the coupon to the customer may be integrated into the payment transaction. Alternatively, this may be effected as a separate transaction in the Host Computer System 12 in batch mode, with the coupon made available for the customer to download (as a Host Rewards 18 record) to a Token 24. The coupon could alternatively be redeemed from the Host Computer System 12 directly by presentation of Token 24, or by presenting a User Id and password, depending on the CID 14, 16 used for the redemption request.

Thus the rewards may, for example, be given to the customer as a reward for using the payment service in the Token 24. Both the first and second Providers may contribute in varying proportions to the cost of the rewards.

Alternatively, the rewards contributed by the first Provider may be kept distinct from the rewards contributed by the second Provider, and each of these types of rewards (given by different Providers) may entitle the customer to different forms and types of benefits, respectively funded by Providers involved.

Pooling of Rewards

The system 10 may also be operated to allow each customer to combine or ‘pool’ his or her rewards with rewards of other customers belonging to a group, to achieve a higher value total reward. Business rules can be effected to limit members of such pooling groups to customers who qualify based on criteria deemed by the Provider or plurality of Contributing Providers to be advantageous to it or them, such as for example limiting pooling to within customers from the same family, or to those having some other form of relationship.

Where Token 24 is used, such pooling of rewards may be effected through online transactions where rewards in the Token 24 of a first Member of a pooling group are transferred to the Host Computer System 12 to the Host Rewards 18 of a second Member (the desired recipient), who is also a member of the pooling group. The Second Member can transfer these rewards to his Token 24 or redeem them directly from the Host Computer System 12. A plurality of such first Members may transfer rewards to the same second Member.

Rewards from the Token 24 of a first Member may also be transferred to the Token 24 of a second Member via a CID/TAD 14. The first Member presents the Token 24 at a CID/TAD 14, which computes the Total Entitlements using the Token Rewards Records 30 and Transaction Details 28 from the Token 24, and writes a ‘transfer from’ Transaction Details 28 record in the Token 24. The Token 24 of a second Member is then presented to the CID/TAD 14, which adds a ‘transfer to’ Transaction Details 28 record to the Token 24 of the second Member.

The transfer transaction is also logged in the CID/TAD 14 for subsequent uploading to the Host Computer System 12. Rewards may also be transferred from the first Member's Host Rewards 18 in the Host Computer System 12 to the second Member's Host Rewards 18 (also in the Host Computer System 12). Alternatively, a plurality of Members may elect to form an automatic pool, so that pooling of the rewards amongst such Members occurs automatically; any one of these Members is permitted to redeem all the rewards (recorded in the Host Rewards 18 in Host Computer System 12) belonging to all of the Members.

A single Member of a pool may also be designated as authorised to redeem. rewards earned by all the Members in the pool.

Standing Instruction for Pooling Transfers

Rewards recorded in Host Rewards 18 on the Host Computer System 12 from multiple first Members can be automatically transferred, by mutual consent, to a designated second Member's Host Rewards 18, from whence it can be transferred to the second Member's Token 24. This transfer is performed at predefined intervals of time or when defined conditions are met (such as when Host Rewards 18 of a first Member reaches a designated level); the Second Member may then redeem the rewards in an offline mode. Such a transfer could be effected, for example, on an automatic, recurrent basis through a ‘Standing Instruction’ issued by Members of the group and recorded in the Host Computer System 12 for automatic execution. In another example, a standing instruction can be established to deduct a first Member's Host Rewards 18 and to credit another account of that first Member, such as a telephone account, a loan account or an insurance premium payable account.

Incentive for Procuring Better Customer Information

By imposing rules and criteria that must be fulfilled for customers to be eligible to form groups, a Provider can provide incentives to customers to, for example, volunteer information about other family members or other potential group members, thus helping the Provider to build a more complete profile of the customers.

Customer Permission

Each Provider or group of Providers has its own set of customer information profile for a respective customer of that Provider or common to that group of Providers. Each CID/TAD 14 accesses a designated Host Computer System 12 (according to the Provider or group of Providers the CID/TAD 14 belongs to) to download and/or update Provider-specific data in the customer's Token 24. Such downloaded data complements the transactional behaviour data that is accumulated in the Token 24 in the course of its use during transactions.

Thus, the Token 24 can be loaded with multiple and more comprehensive customer profiles from different Providers or groups of Providers. The resulting composite profile, with its more complete picture of the customer, can be exploited in the business rules for deriving more relevant and effective customer rewards. For example, a Provider of car accessories may be interested in customers whose profiles indicate that they own cars.

Such sharing of a customer's profile requires the customer's permission. In system 10, where the customer's permission for the sharing of the profile has not been obtained, the CID 14, 16 prompts the customer for permission to use the profile for the particular award computation. The response to a request for such permission (in the affirmative or negative) is recorded in Transaction Details 28 in the Token 24 for use during award computation at time of a redemption, and is also sent to the respective Host Computer System 12 for use during the host-based award computation.

Where a Token 24 is used and the offline business rule (in the CID) for awarding rewards to the customer require access to the customer's profile, and the relevant Provider does not own the customer's profile, the CID/TAD 14 prompts the customer for permission to access the requisite profile for the purpose of the rewards computation. The customer's agreement or refusal is recorded in the Transaction Details 28 in the Token 24. Transaction Details 28 are also recorded in the CID/TAD 14 and periodically transmitted to the Host Computer System 12 for consolidation, reconciliation and reporting. This ensures that the Host Computer System 12 takes into account the customer's consent in the computation of rewards using the customer's profile.

When the customer presents a Token 24 at a CID/TAD 14 for the purpose of redeeming rewards (i.e. to claim some or all of the rewards), the CID 14 computes the customer's total rewards entitlements by taking into account all Token Rewards Records 30 in the Tokens 24 downloaded from the Host Computer System 12, together with details of all Transaction Details 28 recorded in the Tokens 24. Where the computation of rewards requires access to the customer's profile, the award is made only if customer's consent to permit use of his profile is recorded in the transaction record. This ensures that the customer's permission has been sought before the customer's profile information is used for rewards computation.

Plurality of Currency Types Amongst Providers

A plurality of Providers operating in different currencies and doing business in different currencies (referred to as ‘Operating Currencies’), can reward a customer whose Operating Currency is different from the Provider's Operating Currency. Currency conversion rules are established in the Host Computer System 12 of the Providers and downloaded to CIDs; when a customer with a different Operating Currency from that of the immediate Provider is performing a transaction with the Provider, an automatic conversion of any reward values (from Provider's Operating Currency to the customer's Operating Currency and vice versa) is performed either in the Host Computer System 12 if the CID is online or at the CID if it is in an offline mode. This conversion can be performed both for the purpose of awarding rewards as well as for redemption of rewards.

A particular reward type may be contributed to by a plurality of Contributing Providers from different countries. The Contributing Providers may each be operating in a different currency. Each Provider (or its authorised agent) specifies the exchange (both buying and selling) rates of its currency against a Base Currency unit agreed with a Settlement Agency. A first Provider (the ‘Issuing Provider’) whose reward type is being contributed to by other Contributing Providers operates in the Issuing Currency and computes the awards for the customer in the Issuing Currency. This award is then apportioned by the Settlement Agency to the Contributing Providers according to an agreed set of business rules and criteria, in the Issuing Currency, which values are then converted into the Base Currency using the Exchange Rate of the Issuing Currency against the Base Currency. Each Contributing Provider receives information about the amount due from or owing to it either in its Operating Currency or in the Base Currency units, depending on the business rules of settlement.

The Settlement Agency operates a Central Clearing System, which receives transaction and exchange rate information from the Issuing and Contributing Providers or from a third party (such as an operator), and processes the transaction information in order to determine the amounts due to or from each participating Provider. Each Provider may participate in an Issuing capacity, a Contributing capacity, or both Issuing and Contributing capacities. The customer at the second Provider may further be permitted to redeem rewards contributed to by either the First Provider, the Second Provider or both.

The Exchange Rates in the system are set based on mutually agreed business rules and conditions. In most cases, each Provider (or originator of the transaction) sets its own rates (for the customer) against the Base Currency.

Modifications within the scope of the invention may be readily effected by those skilled in the art. It is to be understood, therefore, that this invention is not limited to the particular embodiments described by way of example hereinabove.

For the purposes of this specification it should be understood that the word ‘comprising’ means ‘including but not limited to’, and that the word ‘comprises’ has a corresponding meaning.

1. A transaction system for use by a plurality of users, comprising:
a plurality of electronic tokens for storing and processing token transaction data and token reward data, each of said electronic tokens for use by a respective user;
a computer server for storing and processing server transaction data and server reward data associated with each of said respective tokens; and
a plurality of user interaction devices for communicating with said server, at least one of which is provided with a token acceptor device for reading from and writing to said tokens;
wherein said server transaction data and said token transaction data are indicative of at least one transaction and said server and token reward data are indicative of rewards or entitlements earned or otherwise awarded, and said system is operable to transfer, for a respective token, server reward data from said server to said respective token and token reward data from said respective token to said server by means of said user interaction device provided with a token acceptor device, whereby said rewards or entitlements are redeemable either according to reward data stored on said token or according to reward data stored on said server.

2. A system as claimed in claim 1, wherein said system is operable by each of said users 1) to transfer reward data from said server to a respective token of said respective user so that said respective user can redeem said rewards or reward points by presentation of said token, and 2) to transfer reward data from a respective token of said respective user to said server so that said respective user can redeem said rewards or reward points by communicating with said server.

3. A system as claimed in claim 1, wherein each of said tokens is additionally adapted to store token user data pertaining to said respective user.

4. A system as claimed in claim 3, wherein said server is additionally adapted to store server user data pertaining to said respective user, and said system is operable to synchronize said token user data with said server user data for a respective user when the respective token of said user is used with one of said user interaction devices having a token acceptor device.

5. A system as claimed in claim 1, wherein each of said tokens is any one of: a smart card, a chip in a mobile telephone, a chip in a personal digital assistant, a chip in a watch, and a chip in a key chain, wherein each of said tokens is operable to interact with said token acceptor device.

6. A system as claimed in claim 1, wherein said transaction data includes, for each transaction, unique transaction identification data.

7. A system as claimed in claim 1, wherein said system is operable to transfer data between said server and said tokens so that said system can reconcile said transaction data or said reward data.

8. A system as claimed in claim 1, wherein said user interaction devices are provided with processing software for recording said transaction data and said reward data relating to said transaction in said user interaction device, and to record said transaction data only in said tokens when said tokens are presented at said user interaction devices in the course of a transaction or activity.

9. A system as claimed in claim 8, wherein said system is operable to transmit said transaction data and said respective reward data for each of said transaction records in said user interaction device to said server, and said server is operable to check said transaction data for duplicates, to discard duplicates, to record said transaction data that are not duplicated and to accumulate said respective reward data in said server reward data.

10. A system as claimed in claim 8, wherein said transaction or activity comprises any one of: a purchase transaction, a payment transaction, a cash withdrawal transaction, a transaction to consume or redeem an entitlement, a visit, a subscription to a service, a use of a service, a retrieval of information, a request for information, a submission or provision of information, an application for membership, an access to a web page, a participation in an event, and a registration of a particular activity.

11. A system as claimed in claim 1, wherein each of said tokens is further adapted to store redemption data indicative of previously redeemed rewards or reward points.

12. A system as claimed in claim 11, wherein said user interaction devices are provided with processing software for computing an available balance of entitlements from at least some of said token transaction data, said redemption data, and said token reward data.

13. A system as claimed in claim 1, wherein said user interaction devices are operable to display or print an available balance of entitlements.

14. A system as claimed in claim 1, wherein said user interaction devices are operable to prompt a respective one of said users for an input indicative of whether said respective user wishes to redeem any reward according to an available balance of entitlements in an instant transaction.

15. A system as claimed in claim 1, wherein said server is configured to receive transaction data from said tokens, to compare said received transaction data with previously received transaction data, to discard any duplicated transaction data, and to form a reconciled set of transaction data wherein said reconciled set of transaction data constitutes said server transaction data.

16. A system as claimed in claim 9, wherein at least one of said user interaction devices is equipped with a token acceptor device for retrieving said token transaction data from any of said tokens when said respective token is next used at one of said user interaction devices so equipped, and said respective user interaction device is configured to compute any rewards for a previous transaction the resulting rewards data being sent to said server with said transaction data, whereby said server receives said transaction data and said reward data at least twice.

17. A system as claimed in claim 1, wherein said system is configured to reconcile said token transaction data and said token reward data with said server transaction data and said server reward data when any of said respective tokens is used with a user interaction device provided with a token acceptor device for reading from and writing to said tokens.

18. A system as claimed in claim 1, wherein said system is configured to upload said token transaction data of a respective token to said server and thereby synchronize said respective token with said server, when said token is used with a user interaction device in online mode and provided with a token acceptor device for reading from and writing to said token, where said token transaction data in said respective token had been added to said token when previously used with a user interaction device equipped with a token acceptor device, and where said token transaction data has not been previously transmitted to said server.

19. A system as claimed in claim 1, wherein said server is configured to receive transaction and activity data corresponding to transactions or activities of a respective user on other business systems without using the respective token of said user, for determining rewards or entitlements to be awarded for said transactions and said activities, and recording the balance of such entitlements in said server reward data corresponding to said respective user.

20. A system as claimed in claim 1, wherein said system is configured to associate a respective usemame and password combination with each respective token, so that the respective user associated with said respective token can access said server reward data pertaining to said token by communication with said server and without said respective token.

21. A system as claimed in claim 1, wherein when said token reward data of a respective token is transferred to said server, said transferred token reward data is incorporated into said respective server reward data pertaining to said respective token, and removed from said respective token.

22. A system as claimed in claim 1, wherein when said server reward data corresponding to a respective token is transferred to said respective token, said transferred server reward data is incorporated into said respective token reward data of said respective token, and removed from said server.

23. A system as claimed in claim 1, for use by a plurality of Providers of goods, services or both goods and services

24. A system as claimed in claim 1, for use by a plurality of groups of Providers, each group comprising one or more Providers, each of said groups providing a set of entitlements to said users, and each of said groups having its own set of business rules for awards and redemptions of entitlements, wherein reward data information of said set of entitlements is kept in each of said tokens and, for each of said set of entitlements, said server holds one set of offline reward data and one set of server reward data.

25. A system as claimed in claim 1, wherein rewards can be transferred from a first of said tokens to a second of said tokens by transferring either token reward data or server reward data from said first to said second token.

26. A system as claimed in claim 25, wherein said transfer is effected by means of one or more of said user interaction devices configured to transmit information about said transfer to said server for updating the server reward data corresponding to said first token and said second token.

27. A system as claimed in claim 1, wherein said user interaction devices are located in a plurality of countries, said countries collectively employ a plurality of currencies, and said user interaction devices in each of said countries transact in a respective local currency, and wherein said tokens contain entitlement information based on said token reward data converted to the local currency of the respective user interaction device by said user interactive device or by said server so that an entitlement can be redeemed in a respective country.

28. A system as claimed in claim 1, wherein said system is configured to convert entitlement information awarded by a respective said user interaction device in a local currency to the currency of said respective token.

29. A system as claimed in claim 1, wherein each group of a plurality of groups of Providers maintains in each of said tokens profile data relating to said respective group and of a user of said respective token, wherein a first of said groups of Providers can establish a business relationship with a second of said groups for the purpose of sharing the whole or parts of said profile data relating to said second Group, and ask a particular user at one of said user interaction devices of said first Group, during a transaction or activity, for permission to use said profile data for making an offer relevant to said respective user according to business rules encoded in said user interaction device, wherein user interaction device is provided with a token acceptor device for reading from and writing to said tokens and said user of said respective token can indicate consent by entering a password or PIN, which is used by said user interaction device to access said profile data.

30. A system as claimed in claim 1, wherein said system is operable to allow a first of said users to leave a standing instruction recorded in said server to transfer entitlements from said server reward data to credit a specified account.

31. A system as claimed in claim 30, wherein said specified account is adapted to receive said transferred entitlements as payments of insurance premiums, for telecom bills, utility bills, outstanding loans or for other goods or services, the reward data of another set of entitlements of the same user or the reward data of another set of entitlements of another user, and said transfer can be effected on a regular basis or when a set of specified conditions are met.

32. A system as claimed in claim 1, wherein said transaction comprises an activity, said server transaction data comprises server activity data and said token transaction data comprises token activity data.

33. A method for performing transactions by a plurality of users, comprising:
providing a plurality of electronic tokens for storing and processing token transaction data and token reward data, each of said electronic tokens for use by a respective user;
providing a computer server for storing and processing server transaction data and server reward data associated with each of said respective tokens; and
providing a plurality of user interaction devices for communicating with said server, at least one of which is provided with a token acceptor device for reading from and writing to said tokens;
wherein said server transaction data and said token transaction data are indicative of at least one transaction and said server and token reward data are indicative of rewards or entitlements earned or otherwise awarded, and said system is operable to transfer, for a respective token, server reward data from said server to said respective token and token reward data from said respective token to said server by means of said user interaction device provided with a token acceptor device, whereby said rewards or entitlements are redeemable either according to reward data stored on said token or according to reward data stored on said server.

34. A method as claimed in claim 33, including additionally providing each of said tokens with token user data pertaining to said respective user.

35. A transaction system for use by a plurality of users, comprising:
a plurality of electronic tokens for storing and processing token activity data and token reward data, each of said electronic tokens for use by a respective user,
a computer server for storing and processing server activity data and server reward data associated with each of said respective tokens; and
a plurality of user interaction devices for communicating with said server, at least one of which is provided with a token acceptor device for reading from and writing to said tokens;
wherein said server activity data and said token activity data are indicative of at least one activity and said server and token reward data are indicative of rewards or entitlements earned or otherwise awarded, and said system is operable to transfer, for a respective token, server reward data from said server to said respective token and token reward data from said respective token to said server by means of said user interaction device provided with a token acceptor device, whereby said rewards or entitlements are redeemable either according to reward data stored on said token or according to reward data stored on said server.

36. A system as claimed in claim 9, wherein at least one of said user interaction devices is equipped with a token acceptor device for retrieving said token transaction data and associated reward data from any of said tokens when said respective token is next used at one of said user interaction devices so equipped, and said respective user interaction device is configured to send to said server said transaction data and said associated reward data, whereby said server receives said transaction data and said reward data at least twice.
